(19) United States
(12) Patent Application Publication
(10) Pub. No.: US 2007/0131566 A1
(43) Pub. Date: Jun. 14, 2007

(54) Electrochemical method and system for detection of trace explosives

(75) Inventors: Boris Filanovsky, Jerusalem (IL); Tatyana Bourenko, Jerusalem (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Medis Technologies Ltd., Lod (IL)

(21) Appl. No.: 11/461,001

(22) Filed: Jul. 31, 2006

Related U.S. Application Data
(60) Provisional application No. 60/714,342, filed on Sep. 7, 2005.

(51) Int. Cl. G01F 1/64; G01N 27/26

(52) U.S. Cl. 205/780.5; 204/400

(57) ABSTRACT

An electrochemical system and method for electrochemical detection of both nitro-aromatic and cyclic nitro-amine compounds in a single sample, the system having an electrochemical cell including: (a) a modified working electrode having a surface modified by a chemical modifier; wherein the chemical modifier includes a heterocyclic organic compound in which a heterocycle of the compound includes at least one nitrogen atom.

This application draws priority from U.S. Provisional Patent Application Ser. No. 60/714,342filed Sep. 7, 2005.

### FIELD AND BACKGROUND OF THE INVENTION

The present invention relates to a system and method of detecting traces of nitro-aromatic and cyclic nitro-amine compounds and, more particularly, to an electrochemical system and method of detecting trace quantities of explosives in air, water, and soil.

Common explosives are defined in two broad groups: poly-nitroaromatic explosives and cyclic poly-nitroamine explosives. Exemplary substances of the first group include trinitrotoluene (TNT), dinitrobenzene (DNB), dinitrotoluene (DNT), picric acid, and tetryl. Important exemplary substances of the second group include cyclo-trimethylene-trinitroamine or hexahydro-1,3,5-trinitro-1,3,5-triazine (RDX) and octahydro-1,3,5,7-tetranitro-1,3,5,7-tetrazocine (HMX). It would be advantageous to effect detection of both poly-nitroaromatic and poly-nitroamine compounds in a single sample. Since samples of air, water, etc., are generally taken under ambient conditions, oxygen is a natural component of each sample. Hence, it would be of further advantage to effect such detection in the presence of oxygen, particularly in the case of field-deployed detection systems.

Many methods have been used for explosive trace detection. These methods include gas chromatography with mass-spectrometric (GC/MS), ion mobility mass spectroscopy (IMMS or IMS), X-ray, neutron analysis (NA), nuclear magnetic resonance (NMR), and surface acoustic wave resonators (SAW).

Most explosive detection systems in use today are GC/MS or IMS. The methods are suitable and sensitive under laboratory conditions. However, as articulated by E. Brosha et al. (208^{th} Meeting of the Electrochem. Soc., p.1297, October 2005), “GC/MS are large, typically stationary units and very expensive. The GC steps, while improving selectivity, limit the rate of sampling and make GC/MS unsuitable not only to hand held, also to portal monitoring. IMS is portable, but portable IMS detectors rely on radioactive excitation as an ionization source. Even with very active sources, only a limited number of explosive molecules can be ionized per unit of time and sample volume and this leads to detection of extremely low concentrations”.

X-ray, neutron analysis, and NMR devices are unsuitable for applications requiring compact, hand-held devices Moreover, their dependence on radioactive sources raises various health and safety concerns for the public and for the operators of the devices.

One of the most sensitive and selective methods currently being pursued is an immnunochemical sensor based on the usage of specific antibodies (enzymes). However, these methods require very costly special immune-reagents, as well as controlled environments both for storage and operation, which make them impractical in a field setting. For this reason, many researchers are revisiting solutions based on enzyme sensors and are turning to enzyme-less, chemically modified sensors.

Electrochemical sensors have several advantages compared to the above-mentioned methods. Electrochemical sensors are reliable and have high sensitivity, and have low capital expenditure and operating costs. Additionally, an electrochemical sensor system can be used as a field detector operated by a remote control system, since the electrical nature of the analytical signal (current/potential) can be electronically converted to a digital signal and transmitted to a control unit.

A new, zirconium-based electrochemical explosives sensor has been reported the above-referenced disclosure of E. Brosha, et al. The indirect method used is based on decomposing nitro-compounds to NO₂. The open circuit potential (mixed potential) of zirconium, when heated to 500° C., depends on the NO₂ concentration. The potentiometric registration of the zirconium sensor signal is simple, requiring only a DC voltmeter. However, the response time of the method is about 15 to 20 minutes, and is thus impractical for real-time detection and control.

It is well known that TNT and other nitro-aromatic compounds can be reduced electrochemically, and several voltammetric sensors have been developed based on the electrochemical properties of these nitro-aromatic compounds. J. Wang et al. (Analytica Chimica Acta 361 (1998), 85-91) disclosed, bare carbon and boron-doped carbon (diamond) sensors, for TNT detection, which are compact, portable, stable, and inexpensive. The response time of the voltammetric sensors is not more than 50 to 100 seconds. However, these electrodes lack the requisite sensitivity for many practical applications: the sensitivity is up to several nanoamperes per ppb of TNT, and the detection limit is only 70-110 μg/l (70-110 ppb).

A sensor for detecting (solely) TNT using a bare ultra-micro gold electrode has been disclosed (M. Krausa et al., J. Electroanal. Chem. 461, (1999) 10-13; U.S. Pat. No. 6,521,119). However, the analytical signal is of insufficient magnitude for effective field detection, in which the magnitude of noise signals can be at least several nanoamperes.

A study of the electrochemical behavior of several nitro-aromatic compounds from the TNT group on bare glassy carbon, Pt, Ni, Au, Ag electrodes (A. Hilmy, et al., Anal. Chem. 71 (1999), 873-878, and ibid. 72 (2000), 4677) established that Au, Ag or Ag/Au electrodes are useful for amperometric detection of nitro-aromatic compounds down to a detection level of about 70 ppb to 110 ppb.

It must be emphasized that none of the above methods provides a practical, sensitive, cost-effective solution for detecting nitro-aromatic explosives using field-deployed detection systems. It would appear that, under field conditions, the requisite electrochemical sensitivity to compounds like TNT cannot be achieved using bare electrodes, because of the slow electrochemical electron-transfer kinetics of nitroaromatic compounds. Moreover, such electrodes are even less appropriate for compounds like RDX and HMX, due to the even slower electrochemical electron-transfer kinetics of cyclic nitroamine compounds.

It is well known that chemically modified electrodes can provide increased sensitivity. There exist a number of well-known chemical modifiers for increasing the electron transfer current exchange (or electrochemical reaction constant rate) in trace analysis, including methylene blue, phenazines, methyl violet, alizarin yellow, Prussian blue, thionin, azure A and C, toluidine blue, and ferricyanide, as well as several relatively new chemical modifiers, such as ferrocene and derivates thereof, tetracyanoquino dimethane (TCNQ), tetra-thia-fulvalene (TTF) and quinone and derivates thereof [A. Chanbey, Biosensors & Bioelectronics, 17 (2002) pp. 441-456]. Also, the use of hemin analogues, such as phthalocyanines and porphyrines has been disclosed (U.S. Pat. No. 6,872,786).

PCT Publication No. WO2005/050157 to Filanovsky, which is incorporated by reference for all purposes as if fully set forth herein, teaches a system for electrochemically detecting trace nitro-aromatic compounds in air, using a working electrode having a surface that is chemically modified to increase the electron transfer kinetics of nitro-aromatic compounds. Chemical modifiers of the working electrode surface include amino-aromatic compounds such as aniline and its derivatives.

However, these chemically modified electrodes are unsuitable for detecting trace amounts of explosive cyclic nitro-amine compounds such as RDX and HMX.

Thus, it would be advantageous to have a detection system and method for detecting explosive cyclic nitro-amine compounds, particularly under field conditions. It would be of further advantage to have a detection system and method having the requisite sensitivity for detecting cyclic nitro-amine compounds such as RDX under field conditions. It would be yet of further advantage for such detection system and method to be fast, robust, and cost-effective, and to have the requisite sensitivity for detecting both nitro-aromatic and cyclic nitro-amine compounds in a single sample, and in the presence of dissolved oxygen.

### SUMMARY OF THE INVENTION

The present invention can be used for the detection of nitro-aromatic and cyclic nitro-amine compounds in air, water, or soil samples, even in the presence of dissolved oxygen.

According to the teachings of the present invention there is provided an electrochemical system for electrochemical detection of both nitro-aromatic and cyclic nitro-amine compounds in a single sample, the system having an electrochemical cell including: (a) a modified working electrode having a surface modified by a chemical modifier; wherein the chemical modifier includes a heterocyclic organic compound in which a heterocycle of the compound includes at least one nitrogen atom.

According to further features in the described preferred embodiments, the heterocycle includes at least two nitrogen atoms.

According to still further features in the described preferred embodiments, the heterocycle is made up of at least five members.

According to still further features in the described preferred embodiments, the heterocycle is made up of five members.

According to still further features in the described preferred embodiments, the heterocycle has at least one nitrogen-containing moiety, the moiety selected from the group of moieties consisting of amino, alkyl-amino, and amino-alkyl moieties.

According to still further features in the described preferred embodiments, the heterocycle has at least one moiety, the moiety selected from the group of moieties consisting of hydrogen, alkyl, amide and halide moieties.

According to still further features in the described preferred embodiments, the nitrogen-containing moiety is attached to the nitrogen atom.

According to still further features in the described preferred embodiments, the heterocyclic organic compound includes an imidazolidinic structure.

According to still further features in the described preferred embodiments, the heterocyclic organic compound is includes an imidazolic structure.

According to still further features in the described preferred embodiments, the heterocyclic organic compound includes a pyrrolic structure.

According to still further features in the described preferred embodiments, the heterocyclic organic compound includes a pyrazolic structure.

According to still further features in the described preferred embodiments, the heterocyclic organic compound includes an indol-on.

According to still further features in the described preferred embodiments, the heterocyclic organic compound includes a pyrazol-on.

According to still further features in the described preferred embodiments, the pyrazol-on includes a dialkyl-pyrazol-on.

According to still further features in the described preferred embodiments, at least one alkyl moiety of the dialkyl-pyrazol-on is selected from the group of alkyl moieties consisting of methyl, ethyl, propyl and iso-propyl moieties.

According to still further features in the described preferred embodiments, the imidazolidinic structure includes at least one alkyl moiety.

According to still further features in the described preferred embodiments, at least one alkyl moiety is selected from the group of alkyl moieties consisting of methyl, ethyl, propyl and iso-propyl moieties.

According to still further features in the described preferred embodiments, the imidazolidinic structure is a dialkyl-imidazolidin.

According to still further features in the described preferred embodiments, the dialkyl-imidazolidin includes 1,3,-dimethyl-imidazolidin.

According to still further features in the described preferred embodiments, the working electrode includes at least one electrode material selected from the group of electrode materials consisting of carbon and gold.

According to still further features in the described preferred embodiments, the electrochemical cell further includes: (b) a liquid electrolyte communicating with the working electrode, the electrolyte has a composition including: (i) at least 15%, by weight, of at least one organic solvent for dissolving nitro-aromatic compounds and cyclic nitro-amine compounds, wherein a solubility of RDX in the at least one organic solvent is at least 0.5%, by weight, at 20° C., and (ii) water.

According to still further features in the described preferred embodiments, the composition further includes an alcohol.

According to another aspect of the present invention there is provided an electrochemical method for electrochemical detection of trace compounds, the method including the steps of: (a) dissolving a material that potentially contains cyclic nitro-amine compounds in an electrolyte; (b) immersing a working electrode in the electrolyte, the working electrode having a surface modified by a chemical modifier including a heterocyclic organic compound in which a heterocycle of the compound includes at least one nitrogen atom; (c) applying a varying potential to the working electrode, and (d) measuring an electrical current consequent to the varying potential, thereby providing measurement results indicative of a concentration of the cyclic nitro-amine compounds.

According to still further features in the described preferred embodiments, the heterocyclic organic compound is selected, and the potential is varied, such that the electrical current also provides measurement results indicative of a concentration of nitro-aromatic compounds.

According to still further features in the described preferred embodiments, the heterocycle includes at least two nitrogen atoms.

According to still further features in the described preferred embodiments, the heterocycle is made up of at least five members.

According to still further features in the described preferred embodiments, the chemical modifier and the liquid electrolyte are selected so as to increase a peak current of the nitro-aromatic compounds by a factor of at least 2.5, and so as to increase a peak current of the cyclic nitro-amine compounds by a factor of at least 12, the increase in the peak current being measured against a base case in which a working electrode consist of a bare, unmodified carbon electrode and a liquid electrolyte consists of deionized water.

According to still further features in the described preferred embodiments, the liquid electrolyte contains dissolved oxygen

According to still further features in the described preferred embodiments, the oxygen concentration in the liquid electrolyte is at least one tenth of an oxygen concentration for the liquid electrolyte saturated with oxygen.

According to still further features in the described preferred embodiments, the oxygen concentration in the liquid electrolyte is at least one fourth of an oxygen concentration for the liquid electrolyte saturated with oxygen.

According to yet another aspect of the present invention there is provided an electrochemical system for electrochemical detection of both nitro-aromatic and cyclic nitro-amine compounds in a single sample, the system including an electrochemical cell including: (a) a modified working electrode having a surface modified by a chemical modifier, the working electrode for providing a current as a function of potential; (b) a reference electrode for providing a reference current as a function of potential; (c) an auxiliary electrode for completing an electric circuit within the cell, and (d) a liquid electrolyte disposed between and interacting with the working electrode, the auxiliary electrode, and the reference electrode, wherein the chemical modifier and the liquid electrolyte are selected so as to increase a peak current of the nitro-aromatic compounds by a factor of at least 2.5, and so as to increase a peak current of the cyclic nitro-amine compounds by a factor of at least 12, the increase in the peak current being measured against a base case in which a working electrode consist of a bare, unmodified carbon electrode and a liquid electrolyte consists of deionized water.

According to still further features in the described preferred embodiments, the chemical modifier and the liquid electrolyte are selected so as to increase the peak current of the nitro-aromatic compounds by a factor of at least 2.5, and so as to increase the peak current of the cyclic nitro-amine compounds by a factor of at least 15.

According to still further features in the described preferred embodiments, the chemical modifier and the liquid electrolyte are selected so as to increase the peak current of the cyclic nitro-amine compounds by a factor of at least 20, and most preferably, by at least 25.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1A is a schematic illustration of an electrochemical cell having an inventive, chemically modified working electrode and an inventive background electrolyte;

FIG. 1B is a conceptual scheme of an embodiment of the inventive system for electrochemically detecting nitro-aromatic and/or cyclic nitro-amine compounds;

FIG. 2 provides two plots of measured current as a function of potential in an electrochemical cell of the prior art: Plot A is for a blank solution having no trace explosives, and Plot B is for the same solution, but containing 20 ppm of TNT;

FIG. 3 provides two plots of measured current as a function of potential in an electrochemical cell of the present invention, in which the working electrode is modified with 1,3dimethyl-imidazolidin, and the background solution is an inventive, miscible solution containing acetonitrile, ethylene glycol, and water. Plot A is for a blank solution having no trace explosives, and Plot B is for the same solution, but containing 2 ppm of TNT;

FIG. 4 provides two plots of measured current as a function of potential in an electrochemical cell of the present invention, in which the working electrode is bare (unmodified) carbon paper, and the background solution is an inventive, miscible solution containing acetonitrile, ethylene glycol, and water. Plot A is for a blank solution having no trace explosives, and Plot B is for the same solution, but containing 4 ppm of RDX;

FIG. 5 provides two plots of measured current as a function of potential in an electrochemical cell of the present invention, in which the working electrode is modified with 1,3dimethyl-imidazolidin, and the background solution is an inventive, miscible solution containing acetonitrile, ethylene glycol, and water. Plot A is for a blank solution having no trace explosives, and Plot B is for the same solution, but containing 4 ppm of RDX;

FIG. 6 shows five plots of measured current as a function of potential in the electrochemical cell described with reference to FIG. 5, and wherein the trace explosive is HMX, and

FIG. 7 provides six calibration plots of measured current as a function of potential in the inventive electrochemical cell described with reference to FIG. 5, in which the presence of both nitro-aromatic (TNT) and cyclic nitro-amine (RDX) compounds is detected in a single sample.

### DESCRIPTION OF THE PREFERRED EMBODIMENTS

One embodiment of the present invention is an electrochemical method and device for the detection (determination) of trace explosives. Specifically, the inventive method and device can be used for the detection of both nitro-aromatic and cyclic nitro-amine compounds in a single sample, even in the presence of dissolved oxygen.

The principles and operation of the electrochemical method and device of the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

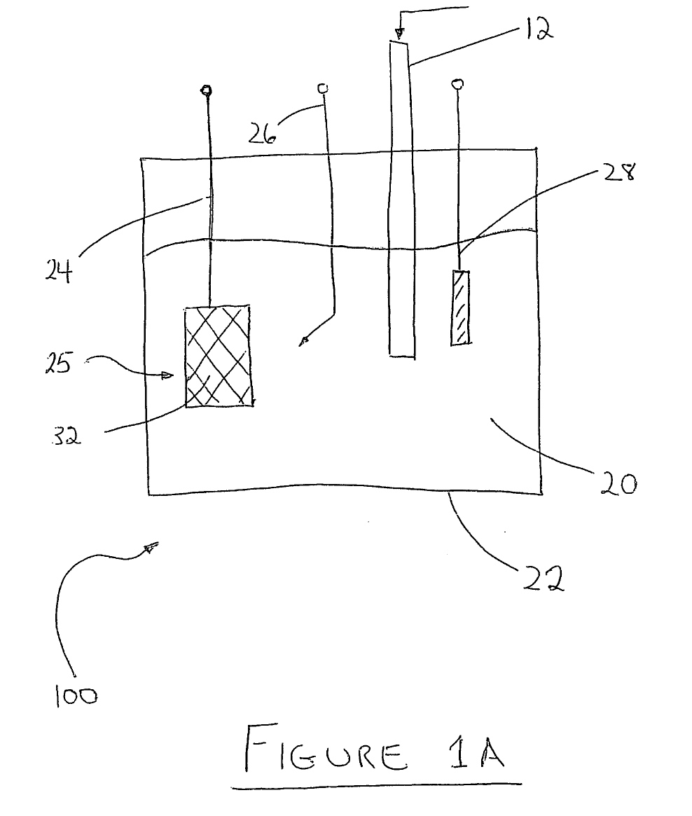

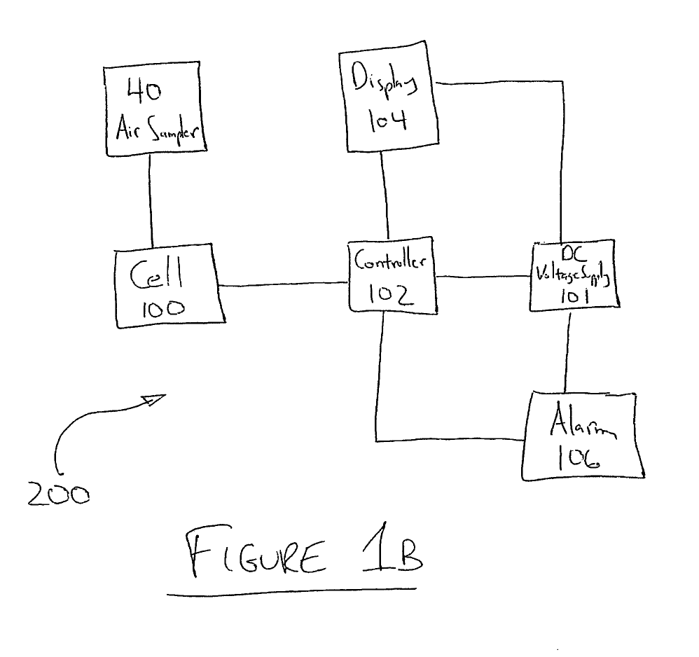

Referring now to the drawings, FIG 1A is a schematic drawing of an exemplary electrochemical cell 100 according to the present invention. An air sample is introduced through a tube 12, into a background electrolyte 20, which is disposed in a housing 22. A lower end of tube 12 is immersed in electrolyte 20. Also immersed in electrolyte 20 are a working electrode 24, a reference electrode 26 and an auxiliary electrode 28. Auxiliary electrode 28 completes the electrical circuit within cell 100. Reference electrode 26 provides a reference potential. The structure and operation of electrochemical cell 100 will be evident to those skilled in the art.

Working electrode 24 has a surface 32 that is preferably modified by at least one of an inventive family of chemical modifiers, as will be described in further detail hereinbelow. Working electrode 24 preferably includes a carbon matrix 25. Carbon matrix 25 may include carbon paper, carbon cloth and related materials. Preferably, matrix 25 is 10-90% porous, and, more preferably, 60-80% porous.

Matrix 25 is advantageously coated or impregnated with nanoparticles and/or microparticles of gold.

Background electrolyte 20 preferably is of an inventive composition that will be described hereinbelow.

In practice, working electrode 24, reference electrode 26 and auxiliary electrode 28 may be disposable electrodes that require replacement after a certain number of detection cycles, preferably not less than 100 cycles. Typically, such disposable electrodes require replacement after at least 2 weeks of intensive work.

One embodiment of an inventive electrochemical system 200 for the electrochemical detection of nitro-aromatic and/or cyclic nitro-amine compounds is provided conceptually in FIG. 1B. A sample, typically an air sample, is introduced to electrochemical cell 100 via air sampler 40. Pre-concentration of the air sample may be effected using various techniques known to those skilled in the art.

A processing unit or controller 102 is electrically connected to a DC voltage supply 101 and to electrochemical cell 100. Controller 102 generates pulses, e.g., a linear sweep, which, when applied to electrochemical cell 100, cause a change in an electrical current, as a function of potential, between working electrode 24 and reference electrode 26. The current response is substantially a linear function of the concentration of the explosive.

After current peaks are generated as a function of voltage, controller 102 identifies the type of explosive compound or the specific identity of the explosive compound, as well as the peak current (that is linearly dependent on concentration) of the explosive compound in solution.

DC voltage supply 101 is also connected to an optional display 104 and an optional alarm 106. Alarm 106 is triggered when controller 102 detects a concentration of the explosive compound that is above a pre-determined value.

Thus, according to one aspect of the present invention there is provided a method of electrochemically detecting trace cyclic nitro-amine compounds, including the steps of: (a) dissolving a sample in an electrolyte; (b) immersing a working electrode in the electrolyte, wherein the working electrode has a surface modified by a chemical modifier including a heterocyclic organic compound in which the heterocycle includes at least one nitrogen atom; (c) applying a varying potential to the working electrode; and (d) measuring the electrical current produced as a function of the varying potential, thereby providing measurement results indicative of a concentration of the trace compounds.

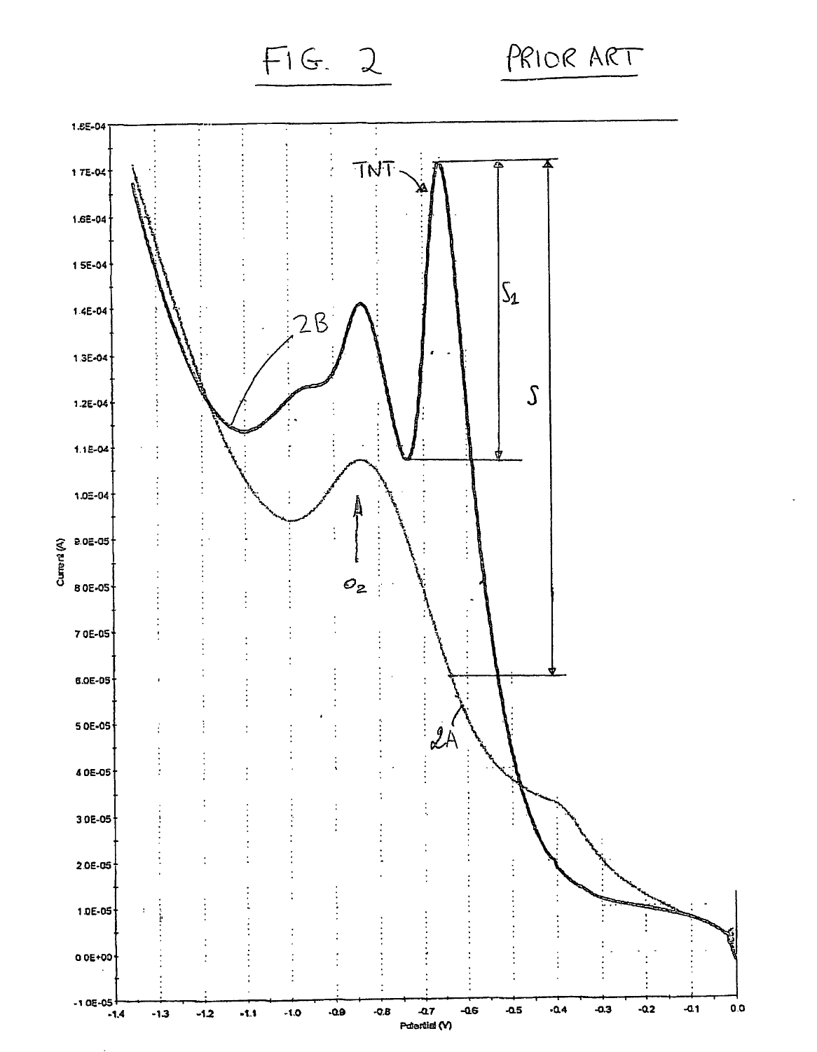

With reference now to FIG. 2, FIG. 2 shows two plots of measured current as a function of potential in an electrochemical cell of the prior art. The working electrode is bare carbon, and the electrolyte is water, buffered with borate to a pH of 8. Electrochemical measurements were made using a PAR (USA) potentiostat/galvanostat model M263A

The parameters of the linear voltammetric regime were as follows:
Eₛₜₐᵣₜ=−0.2 V; E_{finish}=−1.3 V
reference electrode: (Ag/AgCl; sat. KCl);
scan rate:−100 mV/sec;
temperature: 20-22° C.

Plot 2A shows the oxygen reduction signal for a blank solution having no trace explosives. As the plot proceeds (to the left) from a potential of zero at the right-hand side of the plot, a distinct oxygen peak appears at a potential of −0.85V. The shoulder of an additional massive peak, representing hydrogen evolution, reaches a current of 0.17 milliamps at the final voltage of −1.35V.

Plot 2B is for the identical electrochemical cell and identical conditions, but with 20 ppm of TNT added to the electrolyte. As the plot proceeds (to the left) from a potential of zero, the first distinct TNT peak appears at a potential of −0.65V. A second TNT peak appears at a potential of about −0.85V, substantially the same potential as that of the oxygen peak. Thus, the oxygen reduction signal strongly masks the second TNT peak, and the right shoulder of the oxygen peak partially masks the first TNT peak. The sensitivity S, defined by the peak height relative to the baseline curve, is extremely low: approximately 1.1·10⁻⁴ amperes/20ppm TNT, or ≈5.5 microamperes per ppm. In practical terms, TNT concentrations below about 1 ppm (1000 ppb) cannot be detected under these conditions.

Alternatively, sensitivity S₁ can be defined by the peak height, independent of the baseline curve. In this case, the sensitivity S₁ is approximately 0.64·10⁻⁴ amperes/20 ppm TNT, or ≈3.2 microamperes per ppm. In the treatment hereinbelow, sensitivity refers to the peak height relative to the baseline curve (S).

While oxygen can be flushed with an inert gas such as nitrogen, this adds an additional step to the analytical procedure, and increases the cost and the time required for analyzing each sample. Moreover, such a solution is completely impractical for portable field units.

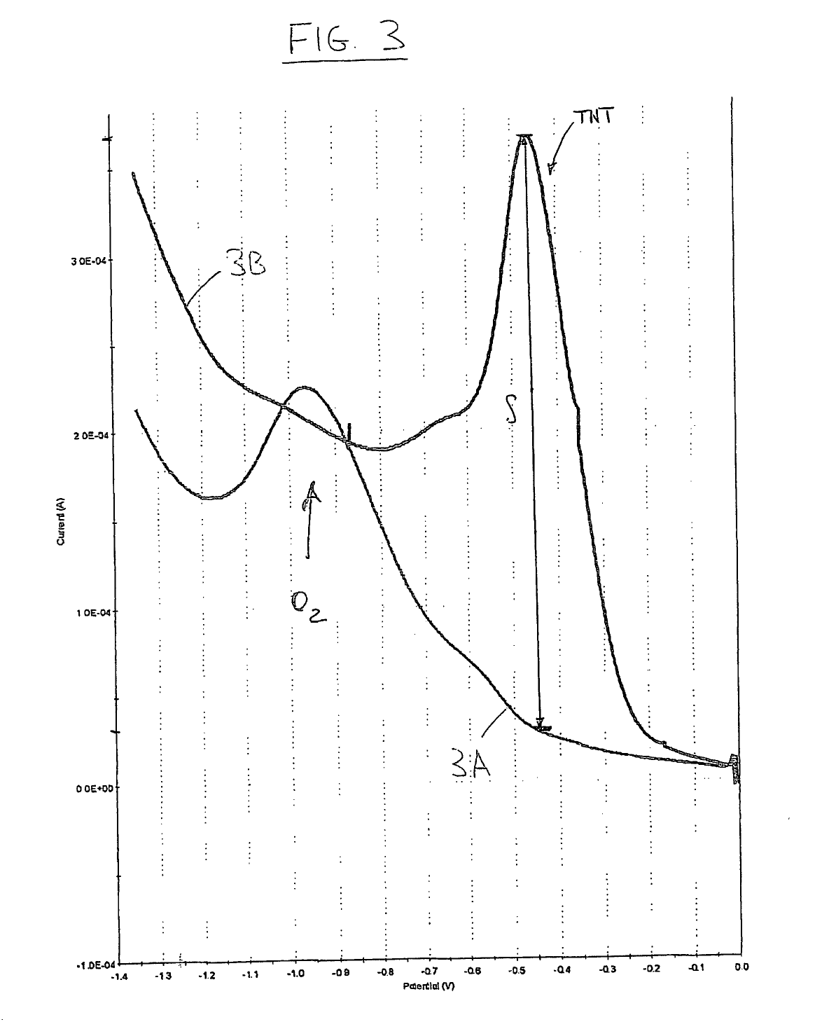

We have surprisingly discovered that by using an inventive chemical modifier for the working electrode, and by using a mixed electrolyte of specific characteristics, the sensitivity for detection of nitro-aromatic compounds is extremely improved, even in the presence of oxygen. FIG. 3 shows two plots of measured current as a function of potential in an electrochemical cell. The exemplary inventive working electrode is the carbon electrode of FIG. 2, modified with 1,3dimethyl-imidazolidin (1,3 DMIz), whose structure is provided below: 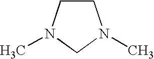
The electrolyte contains ethylene glycol and acetonitrile in a 2:1 ratio (by volume) and water, with 0.01M potassium iodide and 0.01M KCl buffered with borate to a pH of 9.

Plot 3A shows the oxygen reduction signal for a blank solution having no trace explosives. As the plot proceeds from a potential of zero at the right-hand side of the plot, a distinct oxygen peak appears at a potential of −0.95V. In other words, the oxygen peak has shifted by about 0.1V to the left.

Plot 3B is for the identical electrochemical cell and identical conditions as Plot 3A, but with a concentration of 2 ppm of TNT (i.e., 1/10 the amount added to the known electrochemical cell of FIG. 2) in the inventive electrolyte. As the plot proceeds (to the left), a distinct TNT peak appears at a potential of −0.45V, as compared with a potential of −0.65V in the standard electrolyte of Plot 2B. Thus, with the oxygen peak moving to the left by about 0.1V, and with the TNT peak moving to the light by about 0.2V, the TNT peak is well distinguished from the oxygen peak (ΔE≈0.5 V). Without significant masking by the oxygen reduction signal, TNT concentrations of as low as about 10 ppb can be detected under these conditions. The sensitivity S, is approximately 3.310·10⁻⁴ amperes/2 ppm TNT, or about 165 microamperes per ppm. The sensitivity of this chemically modified electrode, in comparison to the sensitivity of the bare carbon paper electrode of FIG. 2, is greater than 25 to 1.

Thus, the electrochemical cell and method of the present invention enable the rapid, sensitive, and inexpensive detection of poly-nitro-aromatic explosives such as TNT, even in the presence of dissolved oxygen. However, it would be highly advantageous to have an electrochemical cell and method for detecting—in a single sample—both poly-nitro-aromatic explosives and cyclic nitro-amine explosives such as RDX and HMX. It must be emphasized that that aniline-based modifiers, disclosed in PCT Publication No. WO2005/050157 to Filanovsky, are specific to nitroaromatics, but have been found to exhibit little specificity to cyclic nitro-amine compounds.

We have discovered, experimentally, that a working electrode modified with a chemical modifier having one or more nitrogen atoms disposed in the ring of a heterocyclic structure, promotes selectivity to explosive nitro-aromatic and explosive cyclic nitro-amine compounds with increased sensitivity. In fact, the inventive modifiers constitute a new class of electrochemical modifiers that exhibit specificity, more generally, to substantially all nitro-aromatic and cyclic nitro-amino compounds, and not only explosive compounds. Several families of heterocyclic structures, such as pyrrol-based heterocycles, indol-based heterocycles, imidazol-based heterocycles, imidazolidin-based heterocycles, and pyrazol-based heterocycles, show activity to —NO₂ and —N—NO₂ electrochemical active groups. Some of these compounds can include an active R═O group, which enhances the specific binding activity to —N—NO₂ groups.

The molecular structures of each basic compound for the above-described families, and the generalized structure thereof, are provided hereinbelow. Some of the above heterocycles include at least two nitrogen atoms within the ring. Many of the heterocycles that have been found to exhibit specificity to nitro-aromatic and cyclic nitro-amino compounds have either five members or six members in the heterocyclic ring.

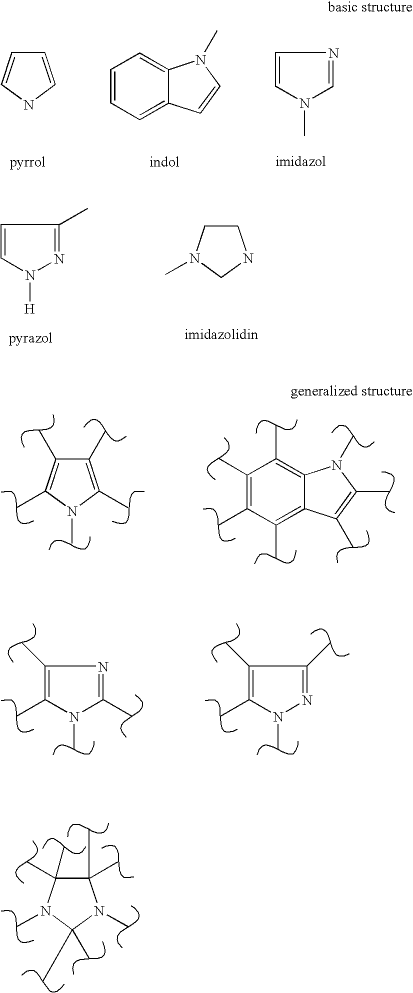

We have experimentally demonstrated that carbon electrodes, modified with pyrrol, indol, imidazol, imidazolidin, or pyrazol, as well as various derivatives of these compounds, show increased sensitivity to nitro-aromatic compounds such as TNT, isomers of dinitrotoluene, and picric acid, and perhaps more significantly, to cyclic nitro-amine compounds such as HMX and RDX, as compared to bare carbon electrodes, and as compared to carbon electrodes modified with modifiers of the prior art. The detection can advantageously be performed in a single sample and in the presence of dissolved oxygen.

As used herein in the specification and in the claims section that follows, the term “heterocycle includes” and the like, with respect to one or more nitrogen atoms, refers to the disposition of one or more nitrogen atoms in the ring of the heterocycle.

As used herein in the specification and in the claims section that follows, the tern “alkyl derivates”, with respect to a heterocyclic molecule containing at least one nitrogen atom in the ring or heterocycle, (e.g., pyrrol, indol, imidazol, imidazolidin, pyrazol), refers to a substituted molecule in which a hydrogen atom has been substituted with an alkyl group. Of these alkyl groups, a group of “lower alkyl” moieties consisting of the methyl, ethyl, propyl and iso-propyl moieties, have been experimentally found to be particularly efficacious in the chemical modifiers of the present invention.

Various moieties have been found, in many instances, to improve the performance of the chemical modifiers of the present invention, with respect to the standard hydrogen moiety. These include amino, alkyl-amino, and amino-alkyl moiety moieties. Without wishing to be bound by theory, one reason for the improved performance may be related to the activity of these moieties to —NO₂ and —N—NO₂ electrochemical active groups. Preferably, at least one nitrogen atom on the moiety is bonded to a hydrogen atom.

The inventors wish to emphasize that various moieties have been found to improve, maintain, or at worst, to not significantly detract from the performance of the chemical modifiers of the present invention, with respect to the standard hydrogen moiety. These include alkyl, preferably lower alkyl moieties, amide, and halide moieties, preferably bromide or iodide.

As used herein in the specification and in the claims section that follows, the term “structure” and the like, with respect, generally, to heterocycles containing one or more nitrogen atoms, and specifically, to heterocyclic families including the imidazolidinic, imidazolic, pyrrolic, pyrazolic, and indolic families, refers to the base molecular ring, devoid of any moieties attached thereto. By way of example, a pyrrolic structure is a five-member heterocycle having two double bonds, four carbon atoms, and one nitrogen atom, and can be illustrated as follows:

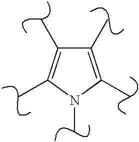

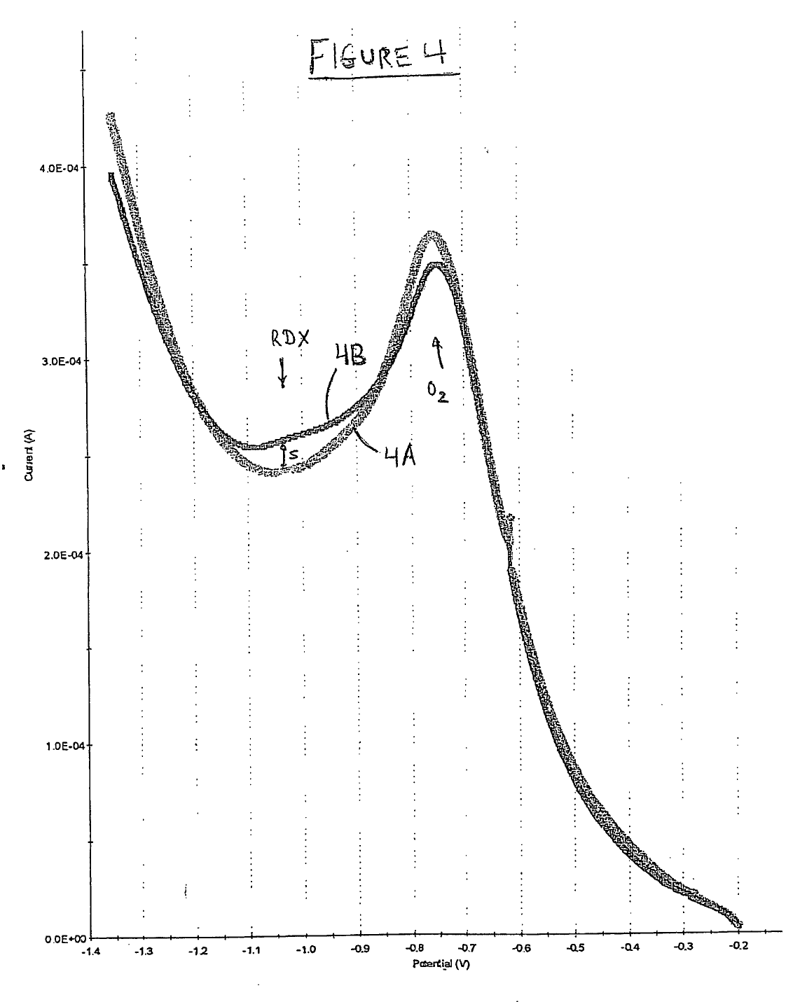

FIG. 4 shows two plots of measured current as a function of potential in an electrochemical cell. The working electrode is bare carbon paper. The electrolyte (described quantitatively in Examples 2.1-2.7 of Table 2 below) contains ethylene glycol, acetonitrile, potassium iodide and potassium chloride, along with water and a borate buffer to bring the pH to 9.0.

Plot 4A shows the oxygen reduction signal for a blank solution having no trace explosives. As the plot proceeds from a potential of zero at the right-hand side of the plot, the first distinct oxygen peak appears at a potential of about −0.75V.

Plot 4B is for the identical electrochemical cell and identical conditions as Plot 4A, but with 4 ppm of RDX added to the electrolyte. As the plot proceeds (to the left), a very slight, poorly defined RDX peak appears at a potential of about −1.05V. The sensitivity S, defined by the peak height relative to the baseline curve, is extremely low: approximately 0.15·10⁻⁴ amperes/4 ppm RDX, or ≈4 microamperes per ppm RDX.

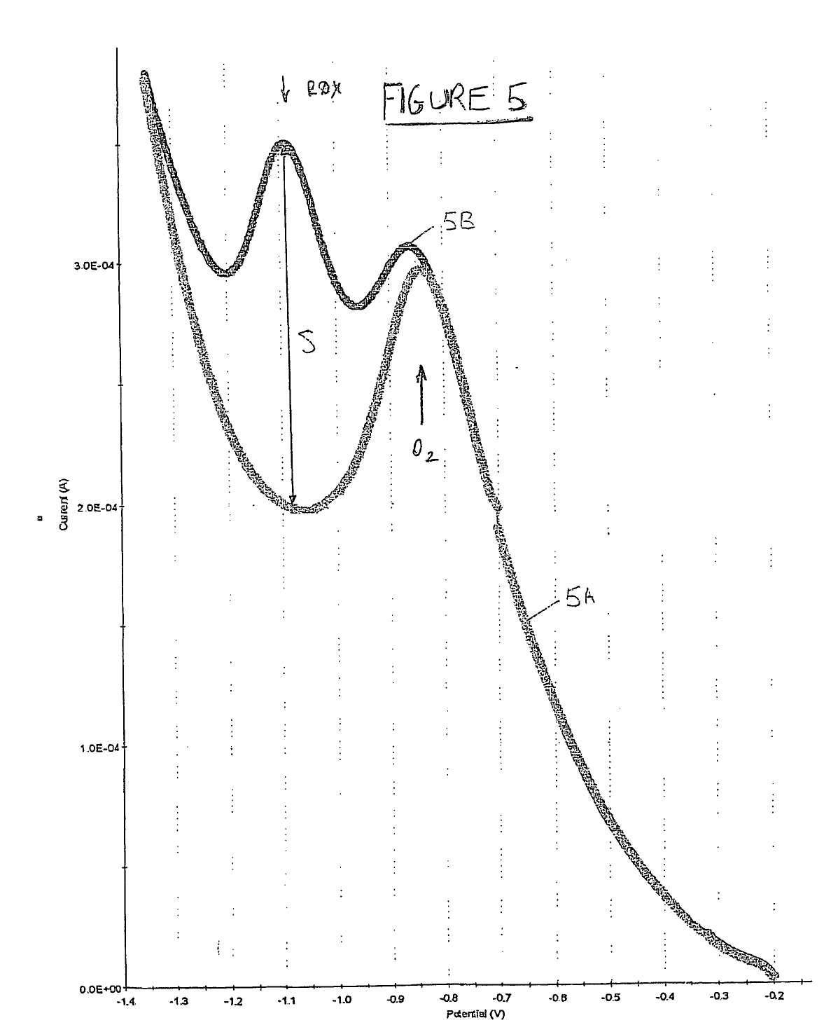

FIG. 5 shows two plots of measured current as a function of potential in an electrochemical cell of the present invention. The working electrode is a carbon paper electrode modified with 1,3dimethyl-imidazolidin (1,3 DMIz). The electrolyte is identical to the electrolyte used in conjunction with FIG. 4.

Plot 5A shows the oxygen reduction signal for a blank solution having no trace explosives. A distinct oxygen peak appears at a potential of about −0.85V.

Plot 5B is for the identical electrochemical cell and identical conditions as Plot 5A, but with 4 ppm of RDX added to the electrolyte. As the plot proceeds to the left, an oxygen peak at about −0.85V—virtually identical to that of the blank—can be discerned.

In sharp contrast to the weak, broad RDX peak obtained in the conventional electrochemical cell (see Plot 4B), the RDX peak in the inventive electrochemical cell is strong and well defined. The sensitivity S, as defined hereinabove, is approximately 1.5·10⁻⁴ amperes/4 ppm RDX, or about 38 microamperes per ppm RDX. The sensitivity of this chemically modified electrode, in comparison to the sensitivity of the bare carbon paper electrode of FIG. 4, is about 10 to 1.

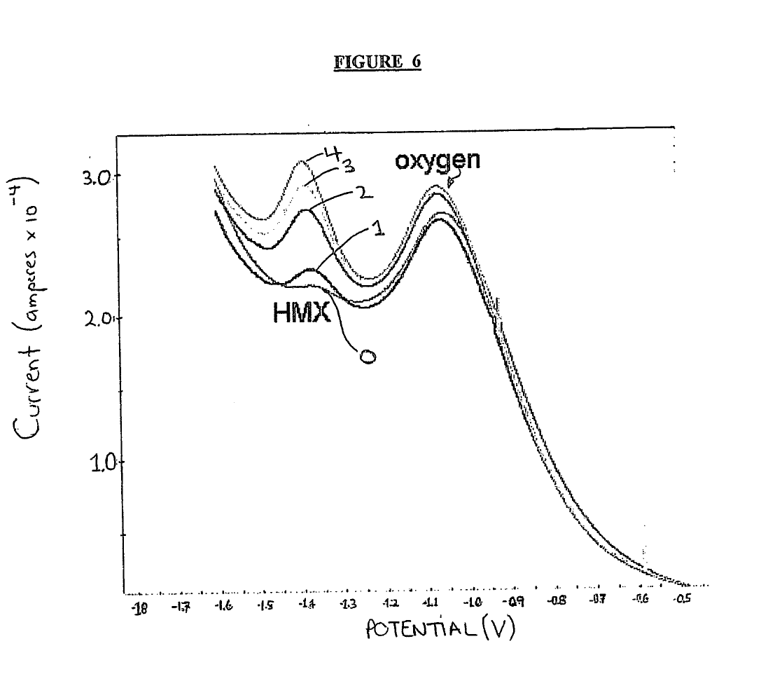

FIG. 6 shows five plots of measured current as a function of potential in an electrochemical cell of the present invention. The working electrode and electrolyte are those described with reference to FIG. 5.

Plot 0 shows the oxygen reduction signal for a blank solution having no trace explosives. A distinct oxygen peak appears at a potential of about −1.05V.

Plot 1 is for the identical electrochemical cell and identical conditions as Plot 0, but with 4 ppm of HMX added to the electrolyte. As the plot proceeds to the left, an oxygen peak at about −1.05V—virtually identical to that of the blank—can be discerned. A well-formed HMX peak develops at a potential between −1.35V and −1.40V. Subsequently, additional amounts of HMX were incrementally added to the electrolyte. Thus, plots 2-4 represent the current peaks for HMX concentrations of 8 ppm, 12 ppm, and 16 ppm, respectively. The sensitivity, as defined hereinabove, is approximately 1·10⁻⁴ amperes/16 ppm HMX, or about 6 microamperes per ppm HMX.

We have shown that specific families of chemical modifiers greatly enhance the electrochemical detection of nitro-aromatic and cyclic nitro-amine compounds, even in the presence of dissolved oxygen. We have also discovered that the composition of the background electrolyte is of great significance in the detection of these compounds.

The multi-component background electrolyte preferably includes an organic component in which both nitroaromatic and cyclic nitro amine compounds are highly soluble and dissolve quickly, an inert component for separating (i.e., increasing the difference in potential between) the problematic oxygen current peak from both the nitroaromatic current peak and the cyclic nitroamine current peak, and an aqueous phase for achieving the requisite electrolytic behavior.

Moreover, we have further discovered that the detection sensitivity of the cyclic nitroamine compounds strongly depends on the composition of the background solution.

Preferably, the organic component includes one or more of the following solvents: dimethylformamide (DMF), dimethylacetamide, tetrahydrofuran (THF), acetonitrile, and propionitrile. Of these, tetrahydrofuran, acetonitrile, and propionitrile are more preferred. For many applications, acetonitrile has been found to have the best overall properties.

Among the numerous criteria for the organic solvents used in the inventive background electrolyte are: solubility of nitroaromatic compounds; solubility of cyclic nitroamine compounds; complete miscibility with the other components of the electrolyte; chemical compatibility with the other components of the electrolyte and with the components of the electrochemical cell; vapor pressure, and dielectric constant.

More specifically, the solubility of RDX (characteristic of the cyclic nitroamine explosives) in the solvent must be at least 0.5%, by weight, at 20° C., more preferably, at least 1%, still more preferably, at least 2%, and most preferably, at least 3%. The solubility of TNT (characteristic of the nitroaromatic explosives) in the solvent must be at least 0.5%, by weight, at 20° C., more preferably, at least 1%, still more preferably, at least 2%, and most preferably, at least 3%. The solubility of TNT is less critical, however, as the sensitivity to nitroaromatic compounds is generally much higher than the sensitivity to the cyclic nitroamine compounds.

The multi-component background solution preferably contains a monovalent chloride such as an alkali metal chloride, Me⁺Cl⁻ (e.g., KCl, NaCl), as an electrolyte. The monovalent chloride is dissolved in a water-organic mixture (for example, water/ethyl alcohol/THF) containing a low concentration of at least one halide (typically, I⁻, Br⁻). The halide presence advantageously enhances the separation of RDX and oxygen peak potentials and also increases RDX detection sensitivity. The pH should preferable be maintained in the range of 7 to 11.5, more preferably, 8.0 to 10.5. Preferably, the concentration of the monovalent chloride is at least 0.03M, and more preferably, 0.05-0.2 M.

The multi-component background solution preferably contains a short-chain alcohol (up to four carbon atoms in length), and containing at least one OH group. These alcohols improve resolution between nitroaromatic compounds, oxygen, and cyclic nitro-amines, and can also reduce background current resulting from oxygen reduction. Presently preferred alcohols include ethylene glycol, ethyl alcohol, propyl alcohol, and isopropyl alcohol.

### EXAMPLES

Reference is now made to the following examples, which together with the description provided hereinabove, illustrate the invention in a non-limiting fashion.

### Examples 1.1-1.6

We have compared, for the experimental examination of our assumption, bare carbon and modified carbon electrode analytical signals in water and multi-component solutions with a pH around 9.0.

We conducted the electrochemical experiments on an M263A potentiostat/galvanostat (PAR, USA), in the different pulse regime (DIP) in a commercial three-electrode cell with a platinum auxiliary electrode and an Ag/AgCl reference electrode.

The modified electrodes were prepared as follows: a carbon-based material, preferably carbon paper or carbon cloth, was anodically oxidized at potentials of 1.3 to 1.5 Volts in 0.1 to 1 M solutions of potassium sulfate (pH=4) for 10 to 15 minutes. Subsequently, the carbon-based material was thoroughly washed with distilled water and dried at 40-50° C. for 20-30 minutes. The treated surface had a surface area of about 0.8 cm². On to the treated surface were dropped 25 μl of a modifier solution in an organic solvent such as acetonitrile (˜2%). Air-drying was then effected for 15-20 minutes.

Experimental data produced in the electrochemical cell is provided in Tables 1 and 2. In these tables, the following notation and abbreviations are

Electrode:

CP—carbon paper;
Sₑₗ—electrode surface area=0.8 cm².
   Modifiers:
3AP—3 amino-pyrazol;
4ABBP-4amino-benzo-pyrazol;
4AzI—4azo-benz-imidazol;
1,3DMIz—1,3dimethyl-imidazolidin;
3APIz—3amino-propyl-imidazol;
SFA—sulfanilamide;
C_{mod}=2% in acetonitrile, modification was conducted with 25 μl modifier for each electrode.
   Background Solution:
v/v—volume/volume basis
W—water
EG—ethylene glycol;
AN—acetonitrile;
pH9—water/borate buffer for adjusting the pH of the electrolyte to 9.0;
Cᵢ=concentration of compound for detecting: C_{TNT}=C_{RDX}=10 ppm.
   Peak Parameters:
   Iₚ—peak current;
   Eₚ—peak potential;
   mka=microamperes.

The parameters of the different pulse regime are as follows:
Eₛₜₐᵣₜ=−0.2 V;
E_{finish}=−1.3 V (Ag/AgCl; sat. KCl);
p1-amplitude: 100 mV;
p1-duration: 0.25 s;
step height: 20.0 mV;
scan rate: 40 mV/s;

temperature: 20-22° C.

TABLE 1

| | | | Iₚ of | Eₚ of | Iₚ of | Eₚ of |
|---|---|---|---|---|---|---|
| Example | | | TNT | RDX | RDX | RDX |
| Number | Modifier | Background Solution | (mka) | (V) | (mka) | (V) |
| 1.1 | Bare CP | pH 9.0 in water | Iₚ₁ = 23 | −0.40 | 1 | −1.05 |
| | | | Iₚ₂ = 16*⁾ | −0.60 | | |
| 1.2 | Bare CP | pH 9.0 + W/EG 1/1_{v/v} | Iₚ₁ = 30 | −0.42 | 5 | −1.05 |
| | | | Iₚ₂ = 15*⁾ | −0.66 | | |
| 1.3 | Bare CP | (pH 9.0 + W + EG + AN) | Iₚ₁ = 32 | −0.42 | 14 | −1.25 |
| | | 1/1/2_{v/v} | Iₚ₂ = 4*⁾ | −0.78 | | |
| 1.4 | 1,3DMIz | pH 9.0 in water | Iₚ₁ = 60 | −0.45 | 15 | −1.08 |
| 1.5 | 1,3DMIz | pH 9.0 + W/EG 1/1_{v/v} | Iₚ₁ = 120 | −0.45 | 15 | −1.12 |
| 1.6 | 1,3DMIz | (pH 9.0 + W + EG + AN) | Iₚ₁ = 180**⁾ | −0.52 | 68 | −1.09 |
| | | 1/1/2_{v/v} + 0.01M | | | | |
| | | KI + 0.1M KCl | | | | |

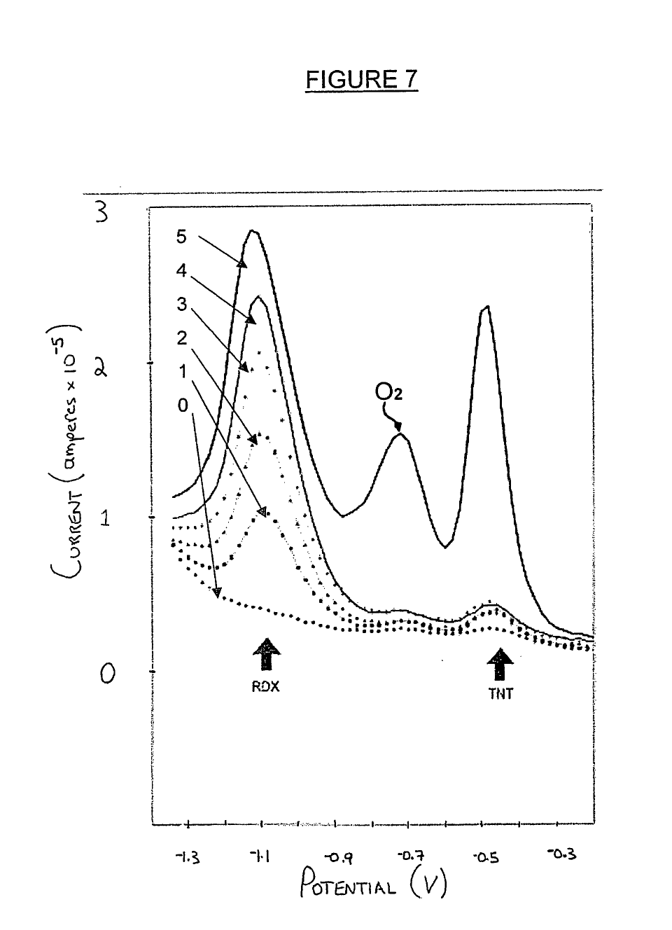

*⁾in 1.1-1.3 background solutions, the TNT analytical signal has two peaks, as observed in the above-referenced article of J. Wang et al. Such a signal is not practical in the presence of oxygen, because the second TNT peak potential practically coincides with the oxygen peak potential.
**⁾Oxygen reduction peak is at −0.78 V, and did not interfere with the TNT and RDX peaks (see also FIG. 7 hereinbelow).

It is evident from the data provided in Table 1 that sensitivity to TNT and RDX depends both on the nature of the electrode modifiers and on the composition of the background solutions. Using bare (unmodified) carbon paper (1.1) in pure water, the background solution is rather sensitive to TNT (2 peaks), but not to RDX, because the cyclic nitro-amine group is more stable to reduction under these conditions. With a bare carbon paper electrode in a background solution containing ethylene glycol and water (1.2), the sensitivity to RDX improves, but is still very low. Surprisingly, in a background solution containing an inventive mixture of ethylene glycol, acetonitrile and water (1.3), the unmodified carbon paper electrode produces a much more pronounced signal for RDX (Iₚ=14mka). It must be emphasized that the inventive electrolyte has little effect on the sensitivity to nitro-aromatic compounds such as TNT.

The carbon paper modified with 1,3dimethyl-imidazolidin in pure water (1.4) provides an unexpected, significantly increased sensitivity, relative to a bare carbon paper electrode, of 60/23 ≈2.6 to 1 with respect to TNT, and an increased sensitivity of ≈15/1 =15 to 1 with respect to RDX. Similarly, the carbon paper electrode modified with 1,3dimethyl-imidazolidin in a background solution containing ethylene glycol and water (1.5), provides an increased sensitivity, relative to a bare carbon paper electrode, of 120/23≈5.2 to 1 with respect to TNT, and an increased sensitivity of ≈15/1 =15 to 1 with respect to RDX. Surprisingly, the same chemically-modified electrode, in the presence of an inventive background solution of ethylene glycol, acetonitrile and water containing dissolved KI and KCl (1.6), produces pronounced TNT and RDX signals. The inventive modified electrode produces a TNT signal having a relative magnitude of about 5.6 to 1 (180/32) with respect to the TNT signal produced by a bare carbon paper electrode in the same mixed background solution (1.3), and an RDX signal having a relative magnitude of about 4.9 to 1 (68/14) with respect to the corresponding RDX signal. A comparison of an inventive modified carbon paper in an inventive background solution (1.6) with a base case of an unmodified carbon paper in a simple background solution (1.1) shows that the sensitivity to TNT increases by a factor of about 7.8 times, and the sensitivity to RDX increases by a factor of about 68.

As used herein in the specification and in the claims section that follows, the term “base case” and the like, with respect to an electrochemical detection test for nitro-aromatic compounds and/or cyclic nitro-amines, refers to an electrochemical reference test in which a working electrode consist of a bare, unmodified carbon electrode and a liquid electrolyte consists of deionized water modified with a borate buffer to a pH of 9.0, and all other cell parameters and cell operating parameters are identical to those of the electrochemical detection test. The deionized water has an electrical conductivity of up to 3 ohm⁻¹cm⁻¹.

### Examples 2.1-2.7

Next, we compared the performance of different modifiers in the inventive background solution. A comparison of different modifier sensitivity on RDX in a multi-component background solution is shown in Table 2. Because of the relatively complicated electrochemical behavior of RDX, Table 2 shows only the RDX reduction data.

TABLE 2

| | | | | |
|---|---|---|---|---|
| | | | | Eₚ |
| Example | | | Iₚ of RDX | of RDX |
| No. | Modifier | Background Solution | (mka) | (V) |

| | | | | |
|---|---|---|---|---|
| 2.1 | Bare CP | (pH9.0 + W + EG + AN) | 8 | −1.15 |
| | | 1/1/2_{v/v} + 0.01M | | |
| | | KI + 0.1M KCl | | |
| 2.2 | SFA | (pH9.0 + W + EG + AN) | 12 | −1.18 |
| | | 1/1/2_{v/v} + 0.01M | | |
| | | KI + 0.1M KCl | | |
| 2.3 | 3AP | (pH9.0 + W + EG + AN) | 38 | −1.16 |
| | | 1/1/2_{v/v} + 0.01M | | |
| | | KI + 0.1M KCl | | |
| 2.4 | 4ABBP | (pH9.0 + W + EG + AN) | 40 | −1.15 |
| | | 1/1/2_{v/v} + 0.01M | | |
| | | KI + 0.1M KCl | | |
| 2.5 | 3APIz | (pH9.0 + W + EG + AN) | 52 | −1.10 |
| | | 1/1/2_{v/v} + 0.01M | | |
| | | KI + 0.1M KCl | | |
| 2.6 | 1,3DMIz | (pH9.0 + W + EG + AN) | 62 | −1.15 |
| | | 1/1/2_{v/v} + 0.01M | | |
| | | KI + 0.1M KCl | | |
| 2.7 | 4AzI | (pH9.0 + W + EG + AN) | 40 | −1.15 |
| | | 1/1/2_{v/v} + 0.01M | | |
| | | KI + 0.1M KCl | | |

The experimental data in Table 2 show that in a suitable background solution, all reagents from the heterocyclic groups of Examples 2.3-2.7 exhibited increased sensitivity to RDX. The highest sensitivity shown was one from the imidazole group: 1,3dimethyl-imidazolidin (2.6). The increased sensitivity, with respect to RDX was 62/8≈7.8 to 1, relative to a bare carbon paper electrode (Example 2.1), and 62/12≈5.2 to 1, relative to a carbon paper electrode modified with an aromatic amine such as sulfanilamide (Example 2.2).

Similarly, a carbon paper electrode modified with a pyrrol—3amino-propyl-imidazol (2.5)—exhibited an increased sensitivity, with respect to RDX, of 52/8≈6.5 to 1, relative to the bare carbon paper electrode, and 52/12≈4.3 to 1, relative to a carbon paper electrode modified with an aromatic amine such as sulfanilamide.

Carbon paper electrodes modified with 3 amino-pyrazol (Example 2.3), 4amino-benzo-pyrazol (Example 2.4), and 4azo-benzo-imidazol (Example 2.7), all demonstrated elevated sensitivities, with respect to RDX: the sensitivity of these compounds was about 40/8=5 to 1, relative to the bare carbon paper electrode, and about 40/12≈3.3 to 1, relative to a carbon paper electrode modified with an aromatic amine such as sulfanilamide.

FIG. 7 shows six calibration plots of measured current as a function of potential in an electrochemical cell of the present invention. The calibration plots are for detecting the presence of both nitro-aromatic and cyclic nitro-amine compounds in a single sample. In this example, TNT is the nitro-aromatic compound, and RDX is the cyclic nitro-amine compound. The background solution was the same as the background solution described in Table 2; the working electrode was modified with 1,3dimethyl-imidazolidin, as described hereinabove.

Plot 0 shows the voltammetric signal or background curve for a blank solution that has been substantially deaerated and has no trace explosives.

Plot 1 is for the identical electrochemical cell and identical conditions as Plot 0, but with the addition of 1.6 μM of RDX (˜0.4 ppm) to the electrolyte. In subsequent plots, additional amounts of RDX were incrementally added to the electrolyte. Thus, plots 2-4 represent the current peaks for RDX concentrations of 0.8 ppm, 1.2 ppm, and 1.6 ppm, respectively. In plot 5, 1.6 μM of TNT (˜0.4 ppm) has been added to the electrolyte, and the electrolyte has been allowed to reach saturation with respect to air, such that there is a presence of oxygen in the electrolyte.

As plot 1 proceeds to the left, a well-formed RDX peak is visible at about −1.1V. Additional amounts of RDX, incrementally added to the electrolyte, result in current peaks at the same voltage, but of greater magnitude (plots 2-4).

Following plot 5 to the left, a large TNT peak is observed at a potential of −0.45V. Subsequently, an oxygen peak appears at about −0.7V. A well-formed RDX peak is visible at the characteristic potential of about −1.1 V.

It must be emphasized that plot 5 clearly demonstrates the viability of the present invention in detecting the presence of nitro-aromatic and cyclic nitro-amines in a single sample. In addition to the excellent sensitivities achieved, the resolution between the voltage peaks of the trace explosive materials and oxygen is sharp: the difference between the voltage peaks of RDX and O₂ is about 380 mV; the difference between the voltage peaks of TNT and O₂ is about 260 mV.

Thus, the electrochemical system and method of the present invention are display high sensitivities to nitro-aromatic and cyclic nitro-amine compounds, even when the electrolyte is substantially saturated with oxygen. This is in sharp contrast to various known technologies, in which the air must be flushed with nitrogen or another inert gas such that the oxygen concentration in the electrolyte is well below one tenth of the saturation concentration.

It will be appreciated that the above descriptions are intended only to serve as examples, and that many other embodiments are possible within the spirit and the scope of the present invention.

What is claimed is:

1. An electrochemical system for electrochemical detection of both nitro-aromatic and cyclic nitro-amine compounds in a single sample, the system comprising an electrochemical cell including:
(a) a modified working electrode having a surface modified by a chemical modifier;
wherein said chemical modifier includes a heterocyclic organic compound in which a heterocycle of said compound includes at least one nitrogen atom.

2. The system of claim 1, wherein said heterocycle of said compound includes at least two nitrogen atoms.

3. The system of claim 1, wherein said heterocycle of said compound is made up of at least five members.

4. The system of claim 3, wherein said heterocycle of said compound is made up of five members.

5. The system of claim 1, wherein said heterocycle has at least one nitrogen-containing moiety, said moiety selected from the group of moieties consisting of amino, alkyl-amino, and amino-alkyl moieties.

6. The system of claim 1, wherein said heterocycle has at least one moiety, said moiety selected from the group of moieties consisting of hydrogen, alkyl, amide and halide moieties.

7. The system of claim 5, wherein said nitrogen-containing moiety is attached to said nitrogen atom.

8. The system of claim 5, wherein said heterocyclic organic compound includes an imidazolidinic structure.

9. The system of claim 5, wherein said heterocyclic organic compound is includes an imidazolic structure.

10. The system of claim 5, wherein said heterocyclic organic compound includes a pyrrolic structure.

11. The system of claim 5, wherein said heterocyclic organic compound includes a pyrazolic structure.

12. The system of claim 5, wherein said heterocyclic organic compound includes an indol-on.

13. The system of claim 5, wherein said heterocyclic organic compound includes a pyrazol-on.

14. The system of claim 8, wherein said imidazolidinic structure includes at least one alkyl moiety.

15. The system of claim 14, wherein at least one of said at least one alkyl moiety is selected from the group of alkyl moieties consisting of methyl, ethyl, propyl and iso-propyl moieties.

16. The system of claim 14, wherein said imidazolidinic structure is a dialkyl-imidazolidin.

17. The system of claim 16, wherein said dialkyl-imidazolidin includes 1,3,-dimethyl-imidazolidin.

18. The system of claim 1, wherein said working electrode includes at least one electrode material selected from the group of electrode materials consisting of carbon and gold.

19. The system of claim 1, said electrochemical cell further including:
(b) a liquid electrolyte communicating with said working electrode, said electrolyte has a composition including:
(i) at least 15%, by weight, of at least one organic solvent for dissolving nitro-aromatic compounds and cyclic nitro-amine compounds, wherein a solubility of RDX in said at least one organic solvent is at least 0.5%, by weight, at 20° C., and
(ii) water.

20. The system of claim 19, said composition further including:
(iii) an alcohol.

21. An electrochemical method for electrochemical detection of trace compounds, the method comprising the steps of:
(a) dissolving a material that potentially contains cyclic nitro-amine compounds in an electrolyte;
(b) immersing a working electrode in said electrolyte, said working electrode having a surface modified by a chemical modifier including a heterocyclic organic compound in which a heterocycle of said compound includes at least one nitrogen atom;
(c) applying a varying potential to said working electrode, and
(d) measuring an electrical current consequent to said varying potential, thereby providing measurement results indicative of a concentration of said cyclic nitro-amine compounds.

22. The method of claim 21, wherein said heterocyclic organic compound is selected, and said potential is varied, such that said electrical current also provides measurement results indicative of a concentration of nitro-aromatic compounds.

23. The method of claim 21, wherein said heterocycle of said compound includes at least two nitrogen atoms.

24. The method of claim 21, wherein said heterocycle of said compound is made up of at least five members.

25. The method of claim 21, wherein said chemical modifier and said liquid electrolyte are selected so as to increase a peak current of the nitro-aromatic compounds by a factor of at least 2.5, and so as to increase a peak current of the cyclic nitro-amine compounds by a factor of at least 12, said increase in said peak current being measured against a base case in which a working electrode consist of a bare, unmodified carbon electrode and a liquid electrolyte consists of deionized water.

26. The method of claim 21, wherein said liquid electrolyte contains dissolved oxygen.

27. The method of claim 21, wherein an oxygen concentration in said liquid electrolyte is at least one tenth of an oxygen concentration for said liquid electrolyte saturated with oxygen.

28. The method of claim 21, wherein an oxygen concentration in said liquid electrolyte is at least one fourth of an oxygen concentration for said liquid electrolyte saturated with oxygen.

29. An electrochemical system for electrochemical detection of both nitro-aromatic and cyclic nitro-amine compounds in a single sample, the system comprising an electrochemical cell including:
(a) a modified working electrode having a surface modified by a chemical modifier, said working electrode for providing a current as a function of potential;
(b) a reference electrode for providing a reference current as a function of potential;
(c) an auxiliary electrode for completing an electric circuit within the cell, and
(d) a liquid electrolyte disposed between and interacting with said working electrode, said auxiliary electrode, and said reference electrode,
wherein said chemical modifier and said liquid electrolyte are selected so as to increase a peak current of the nitro-aromatic compounds by a factor of at least 2.5, and so as to increase a peak current of the cyclic nitro-amine compounds by a factor of at least 12,
said increase in said peak current being measured against a base case in which a working electrode consist of a bare, unmodified carbon electrode and a liquid electrolyte consists of deionized water.

30. The system of claim 29, wherein said chemical modifier and said liquid electrolyte are selected so as to increase said peak current of the nitro-aromatic compounds by a factor of at least 2.5, and so as to increase said peak current of the cyclic nitro-amine compounds by a factor of at least 20.
